(19) United States
(12) Patent Application Publication
(10) Pub. No.: US 2006/0284359 A1
(43) Pub. Date: Dec. 21, 2006

(54) Clamp

(76) Inventors: Colin P. Healy, Western Australia (AU); Simon S. Lyne, Western Australia (AU); Robert P. Healy, Western Australia (AU); Andrew G. Hyde, Western Australia (AU)

Correspondence Address: BACHMAN & LAPOINTE, P.C., 900 CHAPEL STREET, SUITE 1201, NEW HAVEN, CT, 06510, US

(21) Appl. No.: 10/567,920

(22) PCT Filed: Aug. 6, 2004
(86) PCT No.: PCT/AU04/01039

§ 371 Date: Feb. 7, 2006

(30) Foreign Application Priority Data
Aug. 8, 2003 (AU) 2003904181

(51) Int. Cl. B25B 1/04

(52) U.S. Cl. 269/238

(57) ABSTRACT

A clamp comprises two members (12, 14), each of which has a plurality of clamping locations. The clamping locations are configured such that the clamp is able to act against articles of various sizes and shapes. In particular, the clamp has an open region (66) within which curved and irregularly shaped articles can be clamped.

### FIELD OF THE INVENTION

The present invention relates to a clamp.

### BACKGROUND TO THE INVENTION

It is known to require the use of clamps to hold articles relative to one another. One common use for a clamp is in order to hold an article such as a length of wood in a fixed location, such as against a work bench.

A known type of clamp is called a “C” clamp. A C clamp comprises a frame having a clamping point, and a clamping member arranged to move within a threaded aperture within the frame towards and away from the clamping point.

There are several disadvantages with known clamps. These include an inability to successfully clamp items which do not have a flat surface against which a clamping point can rest. A further disadvantage is that the use of known clamps requires locations such as workbenches to be flat near their edge, as the presence of lips and the like can make use of the clamps difficult.

The present invention attempts to overcome at least in part some of the aforementioned disadvantages of previous clamps.

### SUMMARY OF THE INVENTION

In accordance with one aspect of the present invention there is provided a clamp comprising a first clamping member and a second clamping member, the first and the second clamping members being relatively rotatable about a pivot, characterised in that at least one of the first and second clamping members has a plurality of clamping locations, the clamping member being movable between a closed position wherein at least one clamping location of the first clamping member is adjacent at least one clamping location of the second clamping member and an open position wherein the clamping locations of the first clamping member are spaced from the clamping locations of the second clamping member, and wherein an open region is defined between the first and second clamping members when in the closed position. Advantageously, this allows for the clamping together of articles of a variety of shapes, with different clamping locations beings arranged to accommodate differently shaped articles.

Preferably, the first and second clamping members have outer portions which are substantially L-shaped.

Also preferably, the at least one of the clamping members includes a clamping location comprising a ribbed edge.

### BRIEF DESCRIPTION OF THE DRAWINGS

The present invention will now be described, by way of example, with reference to the accompanying drawings, in which:

FIG. 1 is a perspective view of a clamp in accordance with the present invention;

FIG. 2 is a perspective view of an attachment used with the clamp of FIG. 1; and

FIG. 3 is a cross sectional view of the clamp of FIG. 1 together with the attachment of FIG. 2.

### DESCRIPTION OF PREFERRED EMBODIMENTS

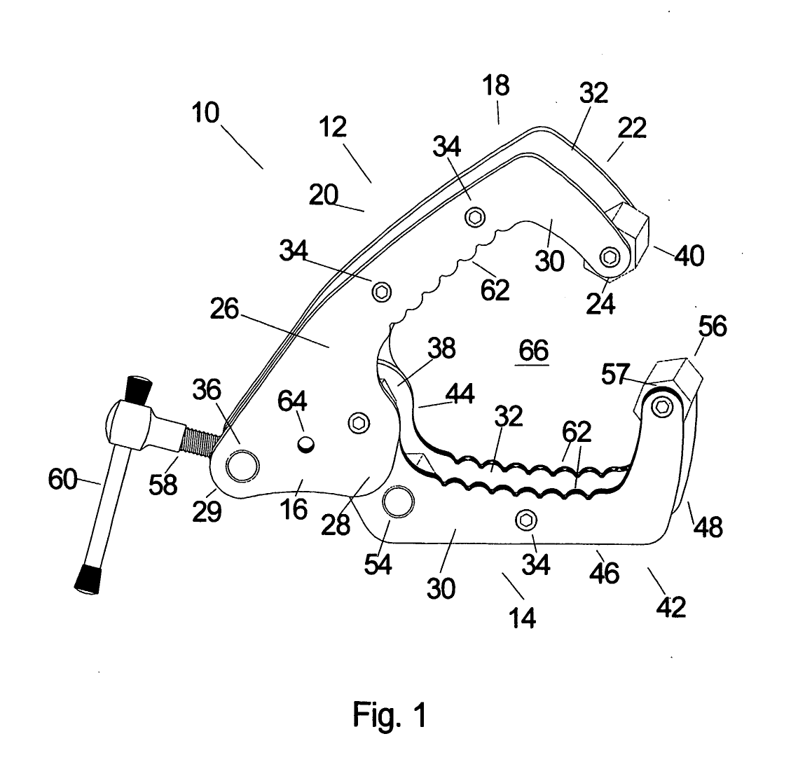

Referring to FIG. 1, there is shown a clamp 10 comprising a first clamping member 12 and a second clamping member 14.

The first and second clamping members 12, 14 are each comprised of two parallel, congruent side members, a first side member 30, and a second side member 32. The side members 30, 32 are preferably formed from plate metal material. Alternately, the side members 30, 32 may be formed of rigid plastics material. Each first side member 30 is connected to a corresponding second side member 32 by at least one fixed spacer 34.

The first clamping member 12 has an inner portion 16 and an outer portion 18.

The outer portion 18 is substantially L shaped, with a long arm 20 extending away from the inner portion 16 and a short arm 22 located remote from the inner portion 16.

The short arm 22 has an outer end 24.

The inner portion 16 is opposed to the short arm 22, and is located on the same side of the long arm 20 as the short arm 22. The inner portion 16 is approximately triangular in shape, having a first vertex 26 adjacent the outer portion 18, a second vertex 28 approximately opposite the outer end 24 of the short arm 22, thus forming a side of the inner portion approximately equal in length to the short arm 22, and a third vertex 29 remote from the outer portion 18.

The first clamping member 12 further includes first, second and third rotating spacers 36, 38 and 40. The rotating spacers 36, 38 and 40 are in the shape of hexagonal prisms, and extend between the first and second side members 30, 32. The rotating spacers 36, 38, 40 are pivotably connected to the first and second side members 30, 32 such that they are able to rotate about an axis perpendicular to the planes of the first and second side members 30, 32.

The first rotating spacer 36 is located adjacent the third vertex 29 of the inner portion 16. The second rotating spacer 38 is located adjacent the second vertex 28 of the inner portion 16. The third rotating spacer 40 is located adjacent the outer end 24 of the short arm 22 of the outer portion 18. The third rotating spacer 40 is arranged such that it extends partially beyond the outer end 24 of the short arm 22.

In the embodiment shown in the drawings, the first and second side members 30, 32 of the first clamping member 12 are connected by two fixed spacers 34, located along the long arm 20 of the outer portion 18.

The second clamping member 14 comprises an L-shaped outer portion 42 and an inner portion 44. The outer portion 42 is substantially identical in size and shape to the outer portion 18 of the first clamping member 12, and has a long arm 46 and a short arm 48. The inner portion 44 extends diagonally away from the inner most point of the long arm 46, in a direction on the same side of the long arm 46 as the short arm 48.

The second clamping member 14 is constructed in a similar fashion to the first clamping member 12, however the spacing between the first side member 30 and the second side member 32 of the second clamping member 14 is slightly smaller than the corresponding spacing in the first clamping member 12, such that the second clamping member 14 can narrowly fit within the gap between the first and second side members 30, 32 of the first clamping member 12.

The second clamping member 14 has a single fixed spacer 34 located along the long arm 46. It has a fourth rotating spacer 54 located at the junction between inner and outer portions 42, 44, and a fifth rotating spacer 56 located adjacent an outer end 57 of the short arm 48 of the outer portion 42. The fifth rotating spacer 56 is arranged such that it extends partially beyond the outer end 57 of the short arm 48.

The clamp 10 is constructed by orienting the first and second clamping members 12, 14 towards each other such that the third and fifth rotating spacers 40, 56 are adjacent. The second clamping member 14 is connected to the first clamping member 12 at the third rotating spacer 38. The first and second side members 30, 32 of the second clamping member 14 each have apertures through which the third rotating spacer 38 passes. In this way, the second clamping member 14 is able to rotate relative to the first clamping member 12 about the third rotating spacer 38, which acts as a pivot. Each of the first spacer 36 and the fourth spacer 54 have an aperture passing between opposed side faces thereof. The apertures are of the same dimension, and are arranged such that when the first and fourth spacers 36, 54 are rotated to appropriate positions the apertures are aligned.

An adjusting bolt 58 is engaged within the apertures of the first and fourth bolts 36, 54. The adjusting bolt 58 is externally threaded, and the aperture of the first spacer 36 is internally threaded so as to complement the adjusting bolt 58. The adjusting bolt 58 has a first end which is held within the fourth spacer 54, and is able to rotate within the aperture of the fourth spacer 54. The adjusting bolt has a second end located outside the inner portion 16 of the first clamping member 12, the second end having a handle 60 associated therewith to assist in rotation of the adjusting bolt 58.

The first and second clamping members 12, 14 each include ribbed clamping edges 62 located along the long arms 20, 46 of both the first and second side members 30, 32. The clamping edges 62 are located along internally facing edges of the long arms 20, 46, so that the clamping edges 62 of the first clamping member 12 are oriented towards the clamping edges 62 of the second clamping member 14.

An aperture 64 passes through the first clamping member 12 centrally of the inner portion 16.

In use, the clamp 10 operates between a closed position and an open position. The closed position is characterised by the relative rotation of the first and second clamping members 12, 14 to a position wherein the third spacer 40 and the fifth spacer 56 are adjacent one another. It will be understood that the L-shaped nature of the outer portions 18, 42 results in an open region 66 being defined between the clamping edges 62.

Relative rotation of the clamping members 12, 14 is achieved about the second spacer 38. The relative position of the clamping members 12, 14 about the second spacer 38 is determined by the length of the adjusting bolt 58 which is between the first and fourth spacers 36, 54. As this length is decreased, by winding of the adjusting bolt 58 resulting in movement of the first spacer 36 along the adjusting bolt 58, the clamp 10 is moved into an open position wherein the third and fifth spacers 40, 56 are spaced from each other.

It will be appreciated that the clamp 10 can be used in a number of different applications. In particular, it will be appreciated that both the first and the second clamping members 12, 14 have a number of clamping locations against which articles can be clamped. The third and fifth spacers 40, 56 can function as first and second clamping locations, allowing articles to be clamped therebetween. Rotation of the third and fifth spacers 40, 56 allows one side of the third spacer 40 to be brought into a position substantially parallel to one side of the fifth spacer. This allows flat articles to be clamped together.

Where the flat surfaces of articles being clamped are not parallel, one of the third and fifth spacers 40, 56 can rotate accordingly

Where one article is a table surface having a lip, the design of the clamp 10 allows the lip to lie within the open region 66.

Where one article is not flat, the clamp 10 can be arranged so that the article is within the open region 66. The internal junction of the long and short arms 20, 22 of the first clamping member 12, forms a third clamping location against which such an article may be clamped, with the corresponding junction between arms 46 and 48 of the second clamping member 14 forming a fourth clamping location. The ribbed clamping edges 62 of the first and second clamping members 12, 14 form fifth and sixth clamping locations respectively.

The aperture 64 may be used for hanging the clamp 10 when not in use.

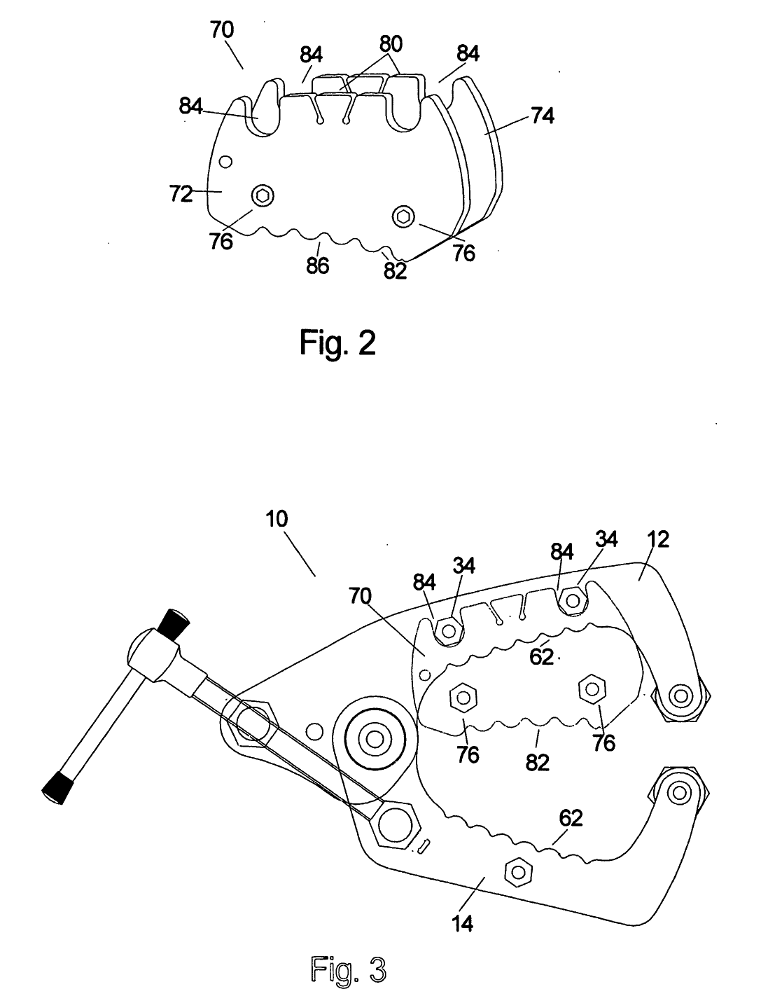

Referring to FIGS. 2 and 3, there is shown an attachment 70 for use with the clamp 10. The attachment 70 is comprised of two parallel, congruent side members 72, 74, preferably formed from plate metal material. The side members 72, 74 are connected to each other by at least one fixed spacer 76. The space between the side members 72, 74 is approximately the same as the space between the first and second side members 30, 32 of the second clamping member 14 of the clamp 10. The attachment 70 thus fits between the first and second side members 30, 32 of the first clamping member 12.

The attachment 70 has an upper edges 80 and lower edges 82. The each upper edge 80 has two receiving indentations 84. The receiving indentations 84 are sized and spaced so as to locate over the two fixed spacers 34 of the first clamping member 12.

The lower edges 82 include ribbed clamping edges 86 similar to the ribbed clamping edges 62 of the clamp 10.

The attachment 70 is sized such that when the receiving indentations 84 are located over the fixed spacers 34 of the first clamping member 12, the clamping edges 86 extend within the open region 66. The clamping edges 86 of the attachment 70 effectively replace the clamping edges 62 of the first clamping portion 12, and thus allow for the clamping of smaller items than can be achieved by the clamp 10 alone. It will be appreciated that the attachment 70 is readily detachable from the clamp 10.

In a preferred embodiment of the invention, the upper edges 80 of the attachment 70 are not parallel to the lower edges 82. The angle between the upper edges 80 and the lower edges 82 is such that the attachment 70 has two distinct configurations. In a first configuration, as shown in FIG. 3, the clamping edges 86 of the attachment 70 are substantially parallel to the clamping edges 62 of the second clamping portion 14 when the clamp 10 is in the closed position.

In a second configuration, where the attachment 70 is turned 180°, the clamping edges 86 are aligned so as to allow an article to be clamped between the fourth clamping locations, that is the conjunction of arms 46 and 48, and the clamping edges 86.

Modifications and variations as would be apparent to a skilled addressee are deemed to be within the scope of the present invention.

1. A clamp comprising a first clamping member and a second clamping member, the first and the second clamping members being relatively rotatable about a pivot, characterised in that at least one of the first and second clamping members has a plurality of clamping locations, the clamping member being movable between a closed position wherein at least one clamping location of the first clamping member is adjacent at least one clamping location of the second clamping member and an open position wherein the clamping locations of the first clamping member are spaced from the clamping locations of the second clamping member, and wherein an open region is defined between the first and second clamping members when in the closed position.

2. A clamp as claimed in claim 1, characterised in that the first and second clamping members have outer portions which are substantially L-shaped.

3. A clamp as claimed in claim 1, characterised in that the at least one of the clamping members includes a clamping location comprising a ribbed edge.

4. A clamp as claimed in claim 3, characterised in that the clamp includes a detachable attachment having a ribbed edge, the attachment being positioned within the open region so as to replace at least one clamping location and allow for the clamping of smaller items.

5. A clamp as claimed in claim 4, characterised in that at least one clamping member is comprised of parallel side members connected by at least one fixed spacer, and wherein the attachment locates over the at least one fixed spacer.

6. A clamp as claimed in claim 5, characterised in that the attachment has two configurations, the orientation of the ribbed edge relative to other clamping locations being different in each configuration.

7. A clamp as claimed in claim 6, characterised in that the first and second clamping members have clamping locations defined by rotatable spacers.

8. A clamp as claimed in claim 7, characterised in that the rotatable spacers are hexagonal.

9. A clamp as claimed in claim 4, characterised in that the attachment has two configurations, the orientation of the ribbed edge relative to other clamping locations being different in each configuration.

10. A clamp as claimed in claim 1, characterised in that the first and second clamping members have clamping locations defined by rotatable spacers.

11. An apparatus comprising:
a work bench;
a piece of wood; and
a clamp as claimed in claim 1, holding the wood against the work bench.

12. A clamp comprising:
a first clamping member having a rotatable end member; and
a second clamping member having a rotatable end member, the first and the second clamping members being relatively rotatable about a pivot to draw the end members together and apart,
wherein:
an open region is defined between the first and second clamping members;
the first and second clamping members have ribbed clamping edges along the open region.

13. The clamp of claim 12 further comprising:
an attachment having a ribbed edge, the attachment being detachably mounted to the first clamping member so that the attachment ribbed edge protrudes beyond the first clamping member ribbed clamping edge.

14. The clamp of claim 12 further comprising:
a single handle; and
an adjusting bolt coupling the handle to the first and second clamping members so that rotation of the handle causes relative rotation of the first and second clamping members.
